(19) United States
(12) Patent Application Publication
(10) Pub. No.: US 2025/0356763 A1
(43) Pub. Date: Nov. 20, 2025

(54) AUTOMATIC AIRCRAFT TAXI SYSTEMS AND METHODS

(71) Applicants: Airbus (S.A.S.), Blagnac Cedex (FR); Airbus Operations (S.A.S.), Toulouse (FR)

(72) Inventors: Pascal LAURENS, Toulouse (FR); Pierre BIZET, Blagnac (FR); Fabien PERRIN, Blagnac (FR); Jonathan RIGAUD, Blagnac (FR); Sebastien SERVOLES, Blagnac (FR); Guillaume LACOUTURE, Blagnac (FR)

(21) Appl. No.: 19/211,889

(22) Filed: May 19, 2025

Related U.S. Application Data
(60) Provisional application No. 63/649,690, filed on May 20, 2024.
(60) Provisional application No. 63/649,710, filed on May 20, 2024.

(51) Int. Cl. G08G 5/51; B64F 1/18

(52) U.S. Cl. CPC G08G 5/51; B64F 1/18

(57) ABSTRACT

An automated taxi system for an aircraft includes a mapping module configured to generate a collaborative map that identifies traffic within the airport environment, a path trajectory module configured to receive digital taxi clearance from an Air Traffic Control (ATC) identifying a destination within the airport environment, such as a designated take-off runway, and to generate a taxi path trajectory to the destination, a guidance module configured to compute guidance instructions based on the taxi path trajectory, and an aircraft protection module configured to identify obstacles or incursion risks on the collaborative map in the taxi path trajectory and to modify the guidance instructions to avoid the obstacles or incursion risks.

### CROSS-REFERENCE TO RELATED APPLICATIONS

This application is a non-provisional application from and claims priority to U.S. Provisional Patent Application No. 63/649,710 entitled “SYSTEMS AND METHODS FOR SMART TRAJECTORY PROTECTION”, and filed on May 20, 2024, and U.S. Provisional Patent Application No. 63/649,690 entitled “AUTOMATIC AIRCRAFT TAXI SYSTEMS AND METHODS”, and filed on May 20, 2024, the entire disclosures of which are incorporated by reference herein.

### TECHNICAL FIELD

The subject matter disclosed herein relates generally to systems and methods for the automated operation of an aircraft. More particularly, the subject matter disclosed herein relates to systems and methods for controlling the operation of an aircraft during a taxi phase in an airport environment.

### BACKGROUND

During the taxi phase of aircraft operation, where the aircraft taxis within an airport environment to a destination, such as a designated runway from which the aircraft will take off, the pilot/operator must perform many tasks including communicating with Air Traffic Control (ATC) to confirm authorization to proceed to the designated take-off runway and departure slot, determine an appropriate taxi speed, identify possible obstacles or incursions along the taxi path, and, when arriving at the designated take-off runway, determine a correct take-off speed and required runway length. Moreover, as another example, another task is to ensure clearance of the designated take-off runway before entering the runway to line up for take-off, or clearance of an intervening runway to be crossed before being able to reach the destination.

Various functional features have been developed and tested to automate such tasks during taxi operation, such as automated guidance, anti-collision protection, digital clearance from Air Traffic Control (ATC), and guidance on the taxiway via lighting systems. However, there still exists room for improvement of such automated operation during the taxi phase to reduce the pilot's workload, taking into account that spurious triggering of alerts and uncomfortable automated actions shall be avoided.

### SUMMARY

In accordance with this disclosure, systems and methods for providing an automated taxi function of an aircraft within an airport environment are provided. In one aspect, an automated taxi system for an aircraft can include a mapping module configured to obtain an airport map representing an airport environment; a path trajectory module configured to receive digital taxi clearance from an Air Traffic Control (ATC) identifying a destination within the airport environment and to generate a taxi path trajectory to the destination; a guidance module configured to compute guidance instructions based on the taxi path trajectory; and an aircraft protection module configured to identify obstacles or incursion risks on the airport map in the taxi path trajectory and to modify the guidance instructions to avoid the obstacles or incursion risks.

In another aspect, a method for providing an automated taxi function of an aircraft within an airport environment can include obtaining an airport map representing the airport environment; receiving digital taxi clearance from an Air Traffic Control identifying a destination within the airport environment; generating a taxi path trajectory to the destination; computing aircraft guidance instructions based on the taxi path trajectory; identifying obstacles or incursion risks on the airport map in the taxi path trajectory; and modifying the guidance instructions to generate modified guidance instructions that avoid the obstacles or incursion risks. In some examples, the method is implemented by a non-transitory computer-readable storage medium having executable instructions stored thereon.

In any preceding or subsequent example, the mapping module can be configured to obtain the airport map by generating a collaborative map based on data received from one or more of the Air Traffic Control (ATC), a network of an airline associated with the aircraft, systems onboard the aircraft, and/or data suppliers associated with the airline. For example, the data from the Air Traffic Control (ATC) can include a ground trajectory of the aircraft and/or taxi clearances for other aircraft within the airport environment. In some examples, the data from the network of the airline can include data from an Operations Control Center (OCC) of the airline, including takeoff time, and/or a flight path or flight trajectory of the aircraft. In some examples, the data captured by systems onboard the aircraft can include data captured by one or more sensors of the aircraft, data from an automatic dependent surveillance-broadcast (ADS-B) system onboard the aircraft, and/or an ADS-contracts (ADS-C) onboard the aircraft. In some examples, the data from data suppliers can include weather data from a weather server, airport data from airport servers, and/or Notice to Air Men (NOTAM) data.

In any preceding or subsequent example, the system can include a virtual assistant module configured to generate a modified taxi path trajectory based on predetermined constraints to be fulfilled during taxiing and information derived from the airport map. In such examples, the guidance module can be configured to compute the guidance instructions based on the modified taxi path trajectory. Further, in some examples, the virtual assistant module can be configured to provide outputs to a pilot of the aircraft to support a continuous monitoring of tasks.

In any preceding or subsequent example, the aircraft protection module can be configured to receive inputs from one or more sensors that identify one or more obstacle, compare the taxi path trajectory to the location of the one or more obstacle, and generate the modified taxi path trajectory that avoids the one or more obstacle. Further, in some examples, the aircraft protection module can be configured to suppress collision detection alerts and intervening actions with respect to ones of the one or more obstacle that are outside the taxi path trajectory.

In any preceding or subsequent example, the aircraft protection module can be configured to execute an anti-incursion function that triggers one or more of automatic braking of the aircraft or an alert to the pilot when approaching an incursion-risk area.

In any preceding or subsequent example, modifying the guidance instructions can further include receiving direct orders from the Air Traffic Control (ATC).

In any preceding or subsequent example, modifying the guidance instructions can further include receiving input from a pilot of the aircraft.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a schematic diagram of an automated taxi system according to an embodiment of the presently disclosed subject matter;

FIG. 2 is a plan view of a taxipath trajectory of an aircraft according to an embodiment of the presently disclosed subject matter;

FIG. 3 is a plan view of a taxipath trajectory of an aircraft according to an embodiment of the presently disclosed subject matter;

FIG. 4 is a process flow that schematically represents an algorithm for activating protection functions according to an embodiment of the presently disclosed subject matter; and

FIG. 5 is a process flow that schematically represents an algorithm for selectively activating an anti-incursion function according to an embodiment of the presently disclosed subject matter.

### DETAILED DESCRIPTION

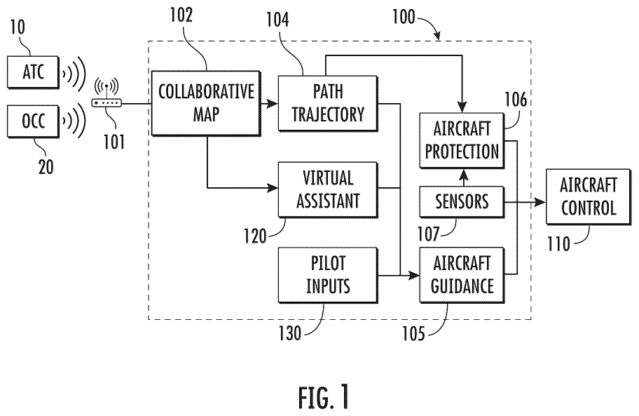

The present subject matter provides systems and methods that provide automated taxi functionality for the phase during which an aircraft travels through the airport until a designated runway to carry out the take-off. In particular, in one aspect, the present subject matter provides an automated aircraft taxi system that integrates a combination of automation features to dramatically reduce pilot workload during the taxi phase of operation. Referring to an example embodiment illustrated in FIG. 1, the automated aircraft taxi system, generally designated 100, is configured to obtain an airport map representing the airport environment through which the aircraft shall carry out the taxi phase. The automated aircraft taxi system 100 is, in some examples, connected to a network 101 that is configured to communicate with ATC equipment 10 and/or an operations control center (OCC) equipment 20 of an airline with which the aircraft is associated to receive the airport map.

In some examples, the network 101 can include any suitable network structure to enable the ATC equipment 10 and the OCC equipment 20 to communicate with computing devices onboard the aircraft, whether on the ground or in the air. For example, the network 101 can include a mobile communications network such as 3G, Long Term Evolution (LTE), 4G, 5G, 6G, or any other suitable mobile communications network. According to another example, the network 101 can include a satellite-based communications network. According to another example, the network 101 can include a wired network, such as for when the aircraft is on the ground at an airport gate, preparing for takeoff, boarding, and/or refueling. In some examples, the network 101 can include a wireless fidelity (Wi-Fi) network or wireless local area network (WLAN), for example, when the aircraft is on the ground and is in close proximity to a wireless access point (WAP).

The automated aircraft taxi system 100 includes a mapping module 102 that is configured to obtain the airport map. In some examples, the airport map identifies traffic within the airport environment. Preferably, the airport map is a collaborative map that includes surrounding airport traffic information based on inputs from several sources including taxi clearances from the ATC equipment 10 and flight dispatch from the OCC equipment 20. In this way, the mapping module 102 improves the communication technology between the pilot, the ATC and the OCC, by providing a structure to support the collaborative map, gathering and updating multiple sources of geo-referenced data, which thus enhances situational awareness of the pilot, the ATC, and the OCC, and optimizes clearance management and supports for weather avoidance.

In addition, the mapping module 102 is configured to receive digital taxi clearance from the ATC equipment 10 identifying a destination (such as a designated take-off runway) and, potentially, waypoints of a taxi path to be followed to reach the destination. Based on these inputs, a path trajectory module 104 can be configured to derive and generate from the taxi path described in the digital taxi clearance received from ATC equipment 10 a taxi path trajectory from the aircraft's location to the designated designation. Based on this taxi path trajectory, a guidance module 105 can be configured to automatically compute guidance instructions to be addressed to aircraft control 110 for the aircraft to follow the taxi path trajectory. Aircraft control 110 corresponds for example to a FCGS (Flight Control and Guidance System) of the aircraft. Thus, following receipt of the digital taxi clearance, the aircraft 1000 can taxi substantially automatically to the destination.

In some examples, a virtual assistant module 120 can be configured to provide further inputs to the guidance module 105 to adapt and/or modify the taxi path trajectory based on any of a variety of additional factors. For this function, the virtual assistant module 120 can be configured to derive information from the collaborative map such that the traffic at the airport can be forecasted. In this way, it is possible for the virtual assistant module 120 to generate a modified taxi path trajectory based on predetermined constraints to be fulfilled during taxiing and the information derived from the collaborative map. The virtual assistant module 120 is thus able to predict in an accurate way if the taxi operations constraints can be fulfilled (e.g., taxi time with regards to departure slot, brakes temperature at the end of the taxi phase), and/or to provide outputs to the pilot to allow a continuous monitoring of tasks that allow optimization of missions of the aircraft taxiing on the ground and in flight. The guidance module 105 can then be configured to compute the guidance instructions based on the taxi path trajectory modified by the virtual assistant module 120.

In some examples, the virtual assistant module 120 can further be configured to identify a best guidance strategy to the guidance module 105, provide a monitoring of the constraints to be fulfilled during taxi, provide all required computation up to take-off (e.g., take-off speeds computation, required runway length), and/or determine full mission feasibility. For example, the virtual assistant module 120 can be configured to extract weather and Notice to Air Men (NOTAM) information as well as documentation data. The virtual assistant module 120 can further be configured to generate a performance forecast based on the weather and NOTAM information and the documentation data. In some examples, the virtual assistant module 120 is configured to predict a takeoff time, taxi time, and flight time based on the flight plan and the weather and NOTAM information and the documentation data, to predict a trajectory of the aircraft based on the extracted data and the predicted takeoff time, taxi time, and flight time, and/or to modify the trajectory in real time depending on a weather event during the flight and other external events. In addition, the virtual assistant module 120 can be configured to provide outputs to the pilots to allow a continuous monitoring of tasks.

In some examples, in parallel to the inputs received from the path trajectory module 104 and/or the virtual assistant module 120, the guidance module 105 can receive further inputs from manual controls 130 onboard the aircraft such that the pilot can provide inputs to modify the taxi path as needed, such as to adjust a taxi speed and/or a speed management strategy. One or more heads-up display within the cockpit can provide information to the pilot regarding computed guidance instructions during the taxi operation.

With the system 100 being configured to substantially automate the aircraft taxiing, however, few inputs may be required from the pilot. Rather, substantially all guidance functions can be automated from the taxi path definition up to the steering of the aircraft. In addition, in some examples, with digital taxi clearance instructions being automatically received, adapted, and executed by the system 100 as discussed herein, direct orders can be transmitted by ATC equipment 10 to control the operation of the aircraft (e.g., “stop”) instead of using conventional communications systems (e.g., radio) to relay such orders to the pilot.

In addition to the automatic computation of guidance instructions based on data in the airport map (e.g., collaborative map) and further inputs from the virtual assistant module 120 and/or the manual controls 130, the system 100 can be configured to provide automated protections against incursion into incursion-risk areas, including but not limited to runways or taxiway crossroads (e.g., in case no specific clearance has been provided beforehand). The automated aircraft taxi system 100 may, in some examples, further be configured to provide automated protection against collisions. The automated aircraft taxi system 100 may, in some examples, further be configured to provide automated protection taxiway excursions.

In this regard, in some examples, the system 100 can include an aircraft protection module 106 that implements an anti-incursion function. In some examples, the aircraft protection module 106 further implements a collision-avoidance function. The aircraft protection module 106 can be configured to receive the taxi path trajectory on the airport map as an input to the anti-incursion function and to identify incursion risks in the taxi path trajectory to the destination. In addition, in some examples, the protection module 106 can receive inputs from a sensing system 107, which can include an array of sensors or a capture system, such as an ADS-B (Automatic Dependent Surveillance-Broadcast) system onboard the aircraft, an ADS-C (Automatic Dependent Surveillance-Contract) system onboard the aircraft, LIDAR (Light Detection And Ranging) systems.

In some examples, the protection module 106 is configured to calculate or predict a trajectory of each object or hazard detected on taxiways of the airport environment. Some objects or hazards may be detected as stationary (i.e., same location at successive time samples) or other objects may be detected as moving (i.e., different locations at successive time samples). The protection module 106 can be configured to predict the trajectory of moving objects taking into account at least of an actual location of the moving objects in question, a direction of movement of the moving objects in question, as well as a layout of the taxiways on the airport map. Indeed, in some examples, the moving objects detected on the taxiways are expected to follow the track of the taxiways.

The protection module 106 can be configured to provide cues to the pilot of the aircraft upon identification of possible incursions into incursion-risk areas, such as a runway (e.g., where other aircraft may be carrying out take-off or landing). The aircraft protection module 106 can further be configured to adapt the guidance instructions to manage the incursion risks, such that the aircraft protection module is configured to execute the anti-incursion function, which triggers automatic braking of the aircraft and/or alerts the pilot when approaching an incursion-risk area. As detailed hereafter, the aircraft protection module 106 can be configured to selectively watch out for (be cautious to) or disregard an entry point to an incursion-risk area, when approaching said entry point, according to whether or not the aircraft is subject to enter said incursion-risk area through said entry point according to the taxi path trajectory on the airport map. Namely, when the aircraft is subject to enter said incursion-risk area through said entry point in view of the taxi path trajectory on the airport map, then the anti-incursion function shall watch out said entry point to the incursion-risk area. The collisions protection module 106 can be configured to engage the automatic braking system to prevent collisions with such obstacles and/or alert the pilot. Alternatively, when the aircraft is not subject to enter said incursion-risk area through said entry point in view of the taxi path trajectory on the airport map, then the anti-incursion function can disregard said entry point to the incursion-risk area.

By integrating these features into the taxi control system 100, a number of advantages can be achieved. For instance, in some examples, the pilot does not have to repeat inputs to the system. Instead, the execution of taxi operation can be initiated upon receipt of the digital clearance, and the taxi path trajectory can be completely forecasted and executed within a single system, giving the global timeline view of the taxi operation to the pilot, while removing the execution task from the pilot. In addition, whereas conventional protection systems often operate in conflict with aircraft guidance systems, the integration of the present protection module 106 with the path trajectory module 104 and guidance module 105 can provide a more seamless scheme for controlling the taxi operations, especially for managing through which entry point to an incursion risk area the aircraft will actually attempt entering the incursion risk area in question. Further, the monitoring and application of taxi constraints can be achieved with the real status of the operation (e.g., traffic on the airport, versus the ability to match the departure slot). Overall, the accumulation of these advantages ensures that the pilot workload is reduced, and the occurrence of errors can be minimized.

The integration of the protection module 106 into the system 100 can further provide improved protection from obstacles and incursion-risks. Specifically, for example, knowing the lateral path of the aircraft to be followed enables the collision protection function to reduce spurious triggering, as the collision protection and/or anti-incursion function has the knowledge that the aircraft trajectory will avoid the detected obstacle. Moreover, in some examples, the collision-avoidance function can be configured to detect uncertainty that detected obstacles will not interfere with the taxi path trajectory as defined, and the collision-avoidance function can be configured to consequently adapt the taxi path trajectory in order to provide margin to avoid or get around the detected obstacles, preferably without having recourse to the automatic braking system of the aircraft and/or alerts to the pilot. This can be achieved thanks to the knowledge of the obstacles in question (position and potential movements) and the knowledge of the taxi path trajectory as originally foreseen by the path trajectory module 104. The guidance module 105 can then be configured to compute the guidance instructions based on the taxi path trajectory modified by the collision-avoidance function.

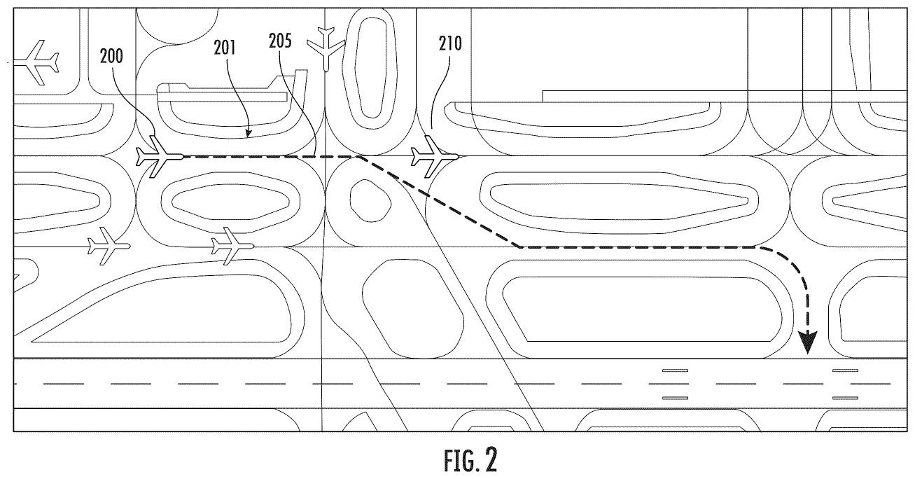

Referring to FIG. 2, conventional collision protection functions may identify a risk that an aircraft 200 traveling forward along a taxiway 201 may collide with another aircraft 210 that is also positioned on taxiway 201. Because an intended taxi path trajectory 205 that is generated by the path trajectory module 104 is an input for the protection module 106, however, the collision avoidance function of the protection module 106 is provided with information that the intended taxi path trajectory 205 of the aircraft 200 will avoid the other aircraft 210. As a result, no alert or intervening action need be triggered and/or collision detection alerts and/or intervening actions can be suppressed by the protection module 106 in such a situation. Therefore, the collision-avoidance function can be configured to selectively disregard or watch out for an obstacle according to whether the obstacle collides with the taxi path trajectory. Accordingly, knowing the taxi path trajectory as input of the collision-avoidance function enables reducing spurious triggering of alerts to the pilot and even enables reducing unnecessary triggering of the automatic braking of the aircraft.

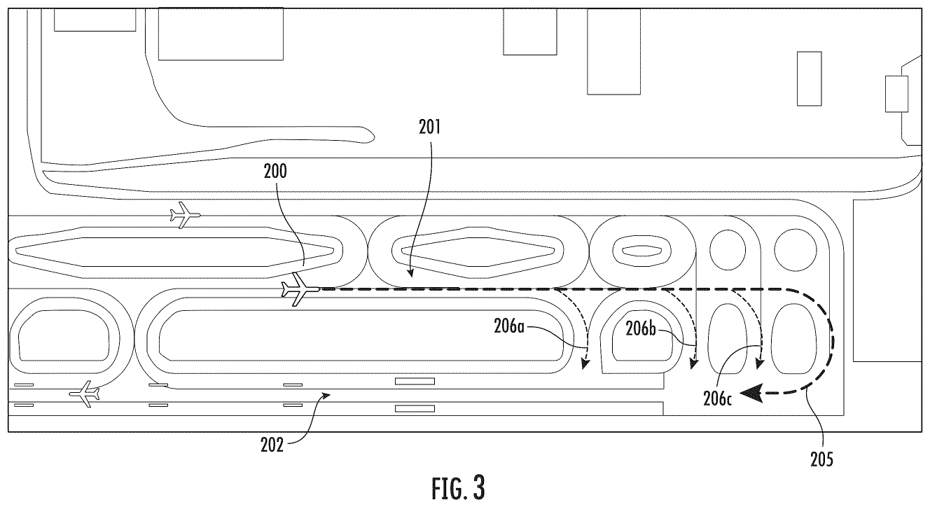

Similarly, knowing the taxi path trajectory enables the runway incursion function to reduce spurious triggering. Referring to FIG. 3, for an aircraft 200 taxiing on a taxiway 201 that runs parallel to a runway 202, there may be multiple runway entries 206a, 206b, and 206c with which the aircraft could potentially engage. Conventional anti-incursion systems may be configured to alert the pilot and/or trigger automatic braking as the aircraft 200 approaches each of the runway entries 206a, 206b, and 206c, particularly if the aircraft is taxiing fast and could possibly turn to take one of the runway entries. Because the intended taxi path trajectory 205 can be an input for the protection module 106, however, these runway entries 206a, 206b, and 206c can be disregarded by the runway incursion function because it is known that the intended taxi path trajectory 205 will bypass these possible incursion positions. As a result, no alert or intervening action need be triggered in such a situation. Accordingly, knowing the lateral path enables the incursion protection function to reduce spurious triggering of alerts and even enables reducing unnecessary triggering of the automatic braking of the aircraft and/or alerts to the pilot.

Although operation of the present system 100 is discussed above with respect to example features, those having ordinary skill in the art will recognize that the operation of the system 100 can be adapted to account for other airport traffic data, taxi operation constraints, guidance strategies, protection functions, or the like. In addition, the present system 100 can be adapted for use on any of a variety of platforms (e.g., legacy aircraft, future aircraft).

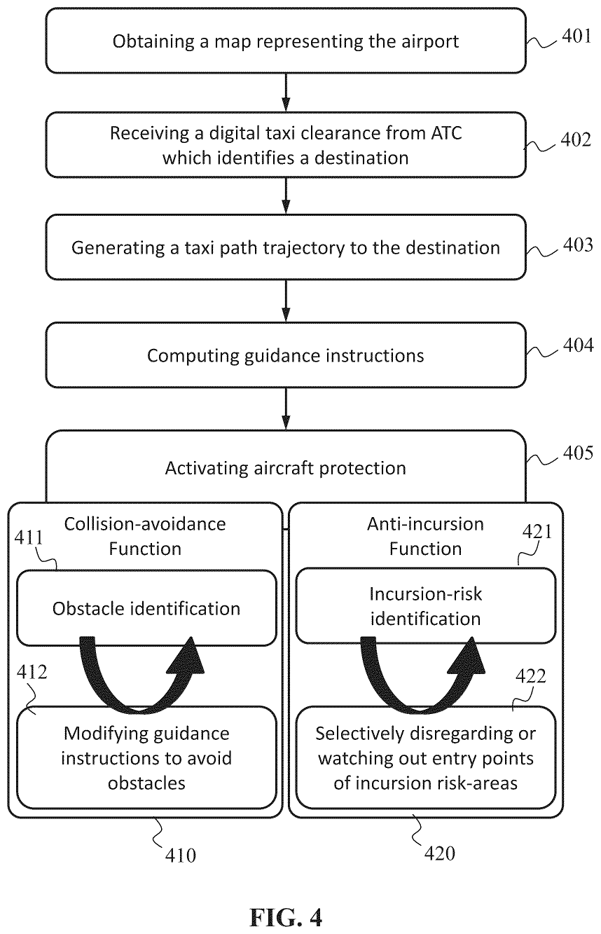

FIG. 4 schematically represents an algorithm for activating protection functions, namely the anti-incursion function and further preferably the collision-avoidance function, in one example. In an acquisition process 401, the automated aircraft taxi system 100 obtains an airport map representing the airport environment. In a taxi clearance process 402, the automated aircraft taxi system 100 obtains a digital taxi clearance from the ATC equipment 10, the digital taxi clearance identifying a destination within the airport environment to which the aircraft is instructed to taxi. In a trajectory generation process 403, the automated aircraft taxi system 100 generates a taxi path trajectory to the destination on the airport map, for example as many conventional navigation systems do. In a guidance computation process 404, the automated aircraft taxi system 100 computes guidance instructions based on the taxi path trajectory, so that the guidance instructions would enable automatically guide the aircraft within the airport environment according to the taxi path trajectory until reaching the destination. In a protection process 405, the automated aircraft taxi system 100 activates at least one aircraft protection. In an anti-incursion process 420, the automated aircraft taxi system 100 activates the anti-incursion function. In a collision-avoidance process 410, the automated aircraft taxi system 100 preferably activates the collision-avoidance function.

Within the anti-incursion function, in a risk identification process 421, incursion-risks are identified, and in a risk clearance process 422, the automated aircraft taxi system 100 selectively disregards or is cautious to entry points to corresponding incursion-risk area with triggering of auto-braking system and/or alerts to the pilot. The anti-incursion function selectively disregards or watches out for entry points, when approaching said entry points, according to whether the aircraft is subject to enter said incursion-risk area through said entry points according to the taxi path trajectory on the airport map. Loops can be performed between the risk identification process 421 and the risk clearance process 422 all along the taxi path trajectory.

Within the collision-avoidance function, in an obstacle identification process 411, obstacles are identified, and in an obstacle clearance process 412, the automated aircraft taxi system 100 modifies guidance instructions to avoid the identified obstacles. Getting around the identified obstacles (i.e., changing the taxi path trajectory) and/or triggering the auto-braking system are possible modifications of the guidance instructions. Loops can be performed between the obstacle identification process 411 and the obstacle clearance process 412 all along the taxi path trajectory. In some examples, one or more obstacles may be disregarded according to whether the obstacle in question collides with the taxi path trajectory.

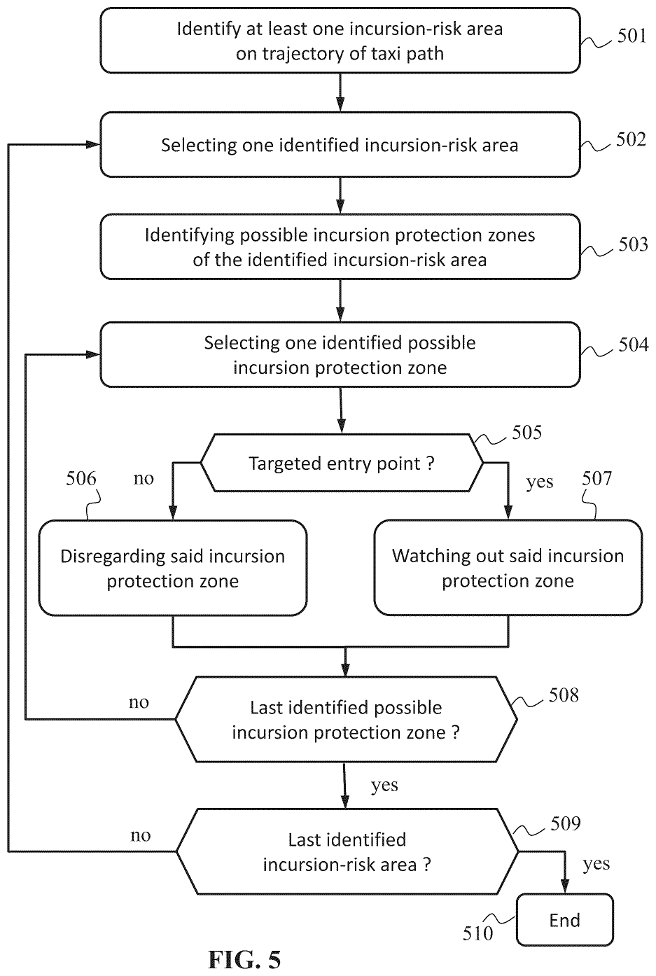

FIG. 5 schematically represents an algorithm for selectively activating the anti-incursion function, according to one example. In an incursion-risk identification process 501, the automated aircraft taxi system 100 identifies at least one incursion-risk area on the taxi path trajectory within the airport environment. The incursion-risk area is for example a runway designated from take-off of the aircraft. The incursion-risk area is for example an intervening runway that the aircraft needs to cross to reach the destination within the airport environment. It can be noted that, when the destination is an airport's gate, there may be no incursion-risk area on the taxi path trajectory, i.e., when there is intervening runway to be crossed to reach the destination; and the destination is a runway from which the aircraft is expected to take-off, said runway is one incursion-risk area and any intervening runway to be crossed to reach the destination is an additional incursion-risk area.

In an incursion-risk area selection process 502, the automated aircraft taxi system 100 selects one incursion-risk area among the at least one incursion-risk area identified in the incursion-risk identification process 501, if any. If no incursion-risk area has been identified in the incursion-risk identification process 501, then the algorithm moves to a resolution process 510 where the algorithm ends. In a protection zone identification process 503, the automated aircraft taxi system 100 identifies possible incursion protection zones of the incursion-risk area selected in the incursion-risk area selection process 502. Such an incursion protection zone is a taxiway zone covering an entry point to the incursion-risk area in question. When reaching such an incursion protection zone, when not disregarded by the anti-incursion function, the automated aircraft taxi system 100 is configured to trigger the auto-braking system and/or alerts to the pilot in situations where the pilot does not instruct the aircraft to brake, unless a runway clearance has been received from the ATC equipment 10 which allows the aircraft to enter the incursion-risk area. The anti-incursion function thus prevents hazardous entry into the incursion-risk area.

Referring again to FIG. 3, considering an incursion-risk area formed by a runway 202 which is on a taxi path trajectory 205 of an aircraft 200 traveling forward along a taxiway 201, multiple runway entry points 206a, 206b, and 206c exist along the taxi path trajectory 205 for the runway 202. Each entry point 206a, 206b, and 206c are associated with a respective incursion protection zone. Conventional anti-incursion systems may be configured to alert the pilot and/or trigger automatic braking as the aircraft 200 enters any one of the incursion protection zones. In order to avoid unnecessary alerts and/or auto-braking, such as at entry points 206a, 206b, and 206c to be bypassed according to the taxi path trajectory 205, the automated aircraft taxi system 100 selectively decides to disregard or watch out for the possible entry points, by taking into account the taxi path trajectory, as disclosed hereafter.

Thus, in an incursion protection zone selection process 504, the automated aircraft taxi system 100 selects one incursion protection zone among the at least one incursion protection zone identified in the protection zone identification process 503. Then, in an incursion protection decision process 505, the automated aircraft taxi system 100 checks whether the selected incursion protection zone corresponds to a targeted entry point to the incursion-risk area in question in view of the taxi path trajectory. With reference to FIG. 3, the targeted entry point to the runway 202 is along the taxi path trajectory 205, whereas the entry points 206a, 206b, and 206c are supposed to be bypassed. When the selected incursion protection zone corresponds to the targeted entry point to the incursion-risk area, an active incursion protection process 507 is performed. Otherwise, in an incursion clearance process 506, the automated aircraft taxi system 100 configures the anti-incursion function to disregard said selected incursion protection zone (since the corresponding entry point to the incursion-risk area is bypassed, in view of the taxi path trajectory). And an incursion protection zone clearance process 508 is then performed to identify whether further incursion protection zones need to be addressed.

In the active incursion protection process 507, the automated aircraft taxi system 100 configures the anti-incursion function to watch out said selected incursion protection zone (since the corresponding entry point to the incursion-risk area is the effective (targeted) entry point to the incursion-risk area, in view of the taxi path trajectory). And the incursion protection zone clearance process 508 is then performed. In the active incursion protection process 507, the automated aircraft taxi system 100 checks whether the last possible incursion protection zone among the at least one incursion protection zone identified in the protection zone identification process 503 has been selected and processed. When at least one incursion protection zone remains to be processed for said incursion-risk area, the incursion protection zone selection process 504 is repeated for selecting another incursion protection zone that remains to be processed for said incursion-risk area. Otherwise, in an incursion-risk area clearance process 509, the automated aircraft taxi system 100 checks whether the last incursion-risk area identified in the incursion-risk identification process 501 has been processed. When at least one incursion-risk area remains to be processed, the incursion-risk area selection process 502 is repeated for selecting another incursion-risk area that remains to be processed for said taxi path trajectory. Otherwise, the algorithm moves to the resolution process 510 where the algorithm ends.

The subject matter disclosed herein can be implemented in or with software in combination with hardware and/or firmware. For example, the subject matter described herein can be implemented in software executed by a processor or processing unit or a programmable computing machine, such as a DSP (Digital Signal Processor). The subject matter disclosed herein can be implemented in hardware form by a machine or a dedicated chip or chipset, such as an FPGA (Field-Programmable Gate Array) or an ASIC (Application-Specific Integrated Circuit). In general, the automated aircraft taxi system 100 and the aircraft's avionics equipment comprise processing electronics circuitry adapted and configured for implementing the subject matter disclosed herein. In some examples, the present subject matter can be implemented by at least one avionics computer of the aircraft, in relation with a display in the cockpit. As an alternative, the present subject matter can be implemented on an EFB (Electronic Flight Bag) device, receiving information from avionics computer(s) of the aircraft.

Some embodiments of the disclosed system may be implemented, for example, using a storage medium, a computer-readable medium or an article of manufacture which may store an instruction or a set of instructions that, when executed by a machine (e.g., processor, processing circuit, or microcontroller), may cause the machine to perform a method and/or operations in accordance with embodiments of the disclosure. In addition, a server or database server may include machine readable media configured to store machine executable program instructions. Such a machine may include, for example, any suitable processing platform, computing platform, computing device, processing device, computing system, processing system, computer, processor, or the like, and may be implemented using any suitable combination of hardware, software, firmware, or a combination thereof and utilized in systems, subsystems, components, or sub-components thereof. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An automated taxi system for an aircraft comprising:
a mapping module configured to obtain an airport map representing an airport environment;
a path trajectory module configured to receive digital taxi clearance from an Air Traffic Control (ATC) identifying a destination within the airport environment and to generate a taxi path trajectory to the destination;
a guidance module configured to compute guidance instructions based on the taxi path trajectory; and
an aircraft protection module configured to identify obstacles or incursion risks on the airport map in the taxi path trajectory and to modify the guidance instructions to avoid the obstacles or incursion risks.

2. The system of claim 1, wherein the airport map is a collaborative map that includes data received from one or more of the Air Traffic Control (ATC), a network of an airline associated with the aircraft, systems onboard the aircraft, or data suppliers associated with the airline.

3. The system of claim 2, wherein the data from the Air Traffic Control (ATC) includes one or more of a ground trajectory of the aircraft or taxi clearances for other aircraft within the airport environment;
wherein the data from the network of the airline includes one or more of data from an Operations Control Center (OCC) of the airline, including takeoff time, or a flight path or flight trajectory of the aircraft;
wherein data captured by systems onboard the aircraft includes one or more of data captured by one or more sensors of the aircraft, data from an automatic dependent surveillance-broadcast (ADS-B) system onboard the aircraft, or an automatic dependent surveillance-contracts (ADS-C) onboard the aircraft; and
wherein data from data suppliers includes one or more of weather data from a weather server, airport data from airport servers, or Notice to Air Men (NOTAM) data.

4. The system of claim 1, comprising a virtual assistant module configured to generate a modified taxi path trajectory based on predetermined constraints to be fulfilled during taxiing and information derived from the airport map;
wherein the guidance module is configured to compute the guidance instructions based on the modified taxi path trajectory.

5. The system of claim 4, wherein the virtual assistant module is configured to provide outputs to a pilot of the aircraft to support a continuous monitoring of tasks.

6. The system of claim 1, wherein the aircraft protection module is configured to:
receive inputs from one or more sensors that identify one or more obstacle;
compare the taxi path trajectory to a location of the one or more obstacle; and
generate the modified guidance instructions that avoids the one or more obstacle.

7. The system of claim 6, wherein the aircraft protection module is configured to suppress collision detection alerts and intervening actions with respect to ones of the one or more obstacle that are outside the taxi path trajectory.

8. The system of claim 1, wherein the aircraft protection module is configured to execute an anti-incursion function that triggers one or more of automatic braking of the aircraft or an alert to the pilot when approaching an incursion-risk area.

9. A method for providing an automated taxi function of an aircraft within an airport environment, the method comprising:
obtaining an airport map representing an airport environment;
receiving digital taxi clearance from an Air Traffic Control (ATC) identifying a destination within the airport environment;
generating a taxi path trajectory to the destination;
computing aircraft guidance instructions based on the taxi path trajectory;
identifying obstacles or incursion risks on the collaborative map in the taxi path trajectory; and
modifying the guidance instructions to generate modified guidance instructions that avoid the obstacles or incursion risks.

10. The method of claim 9, wherein obtaining the airport map comprises generating a collaborative map comprising data received from one or more of the Air Traffic Control (ATC), a network of an airline associated with the aircraft, systems onboard the aircraft, or data suppliers associated with the airline.

11. The method of claim 10, wherein the data from the Air Traffic Control (ATC) includes taxi clearances for other aircraft within the airport environment.

12. The method of claim 10, wherein the data from the network of the airline includes data from an Operations Control Center (OCC) of the airline, including one or more of takeoff time, a ground trajectory, a flight path, or a flight trajectory of the aircraft.

13. The method of claim 10, wherein data captured by systems onboard the aircraft includes one or more of data captured by one or more sensors of the aircraft, data from an automatic dependent surveillance-broadcast (ADS-B) system onboard the aircraft, or an automatic dependent surveillance-contracts (ADS-C) onboard the aircraft.

14. The method of claim 10, wherein data from data suppliers includes one or more of weather data from a weather server, airport data from airport servers, or Notice to Air Men (NOTAM) data.

15. The method of claim 9, wherein computing aircraft guidance instructions comprises generating a modified taxi path trajectory based on one or more of predetermined constraints to be fulfilled during taxiing, computed flight predictions, or information derived from the airport map.

16. The method of claim 9, wherein modifying the guidance instructions comprises:
receiving inputs from one or more sensors that identify one or more obstacle;
comparing the taxi path trajectory to a location of the one or more obstacle; and
generating the modified guidance instructions to avoid the one or more obstacle.

17. The method of claim 16, comprising suppressing collision detection alerts and intervening actions with respect to ones of the one or more obstacle that are outside the taxi path trajectory.

18. The method of claim 9, wherein modifying the guidance instructions further comprises receiving direct orders from the Air Traffic Control (ATC).

19. The method of claim 9, wherein modifying the guidance instructions further comprises receiving input from a pilot of the aircraft.

20. The method of claim 9, comprising providing outputs to a pilot of the aircraft to support a continuous monitoring of tasks.

21. A non-transitory computer-readable storage medium having executable instructions stored thereon, which when executed by a processing circuit of a computing device causes the computing device to:
obtaining an airport map representing an airport environment;
receive digital taxi clearance from an Air Traffic Control identifying a destination within the airport environment;
generate a taxi path trajectory to the destination;
compute aircraft guidance instructions based on the taxi path trajectory;
identify obstacles or incursion risks on the collaborative map in the taxi path trajectory; and
modify the guidance instructions to generate modified guidance instructions that avoid the obstacles or incursion risks.
